(19) United States
(12) Patent Application Publication
(10) Pub. No.: US 2025/0295992 A1
(43) Pub. Date: Sep. 25, 2025

(54) CUSTOMISABLE PERIPHERAL DEVICE AND ASSOCIATED METHOD

(71) Applicant: Sony Interactive Entertainment Inc., Tokyo (JP)

(72) Inventors: Richard Downey, London (GB); Simon Andrew St John Brislin, London (GB); David Erwan Damien Uberti, London (GB)

(73) Assignee: Sony Interactive Entertainment Inc., Tokyo (JP)

(21) Appl. No.: 19/068,609

(22) Filed: Mar. 3, 2025

(30) Foreign Application Priority Data
Mar. 20, 2024 (GB) 2403955.4

(51) Int. Cl. A63F 13/42; A63F 13/213; A63F 13/22; A63F 13/25; A63F 13/98

(52) U.S. Cl. CPC A63F 13/42; A63F 13/213; A63F 13/22; A63F 13/25; A63F 13/98

(57) ABSTRACT

A system for enabling user interactions with interactive content executed by a processing device, the system comprising a peripheral device comprising one or more first input elements, one or more customisation units comprising one or more second input elements, wherein the customisation units are modular units associated with the peripheral device by a user, a mapping generation unit configured to generate an input mapping, wherein the input mapping comprises one or more functions assigned to the one or second input elements which are not able to be assigned to the first input elements.

### BACKGROUND OF THE INVENTION

### Field of the invention

This disclosure relates to a customisable peripheral device and associated method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

When engaging with interactive content, the choice of peripheral that a user uses to provide inputs is often a significant decision. This is because different peripherals may provide significantly different functionality—for instance, some peripherals are designed for a motion-based input (such as tracking gestures using a camera) while others are designed for a button-based input. This, in addition to the form factor of the peripheral, can make a significant difference to the level of immersion experienced by a user when engaging with the interactive content.

In some cases, peripherals are designed for a very specific use case—these often have a form factor which is intended to mimic an object used in game (such as a gun-shaped or steering wheel controller). While these may offer a high degree of immersion for a specific interactive experience, this can be impractical due to the tailoring of these peripherals to those experiences. For instance, a reduced number of buttons may be provided, and/or the form factor may render the controller undesirable for alternative use. As a result, a user is required to obtain a significant number of peripherals to support this functionality.

An alternative approach is to provide a more general-purpose peripheral which is intended for use for a range of interactive content. While this may not generate the same level of immersion for a user, the ability to use the peripheral for a range of content may be considered suitably advantageous. However, there may still be a desire for a more immersive experience through the provision of a more specific peripheral.

One approach to addressing this is to provide mounts or other accessories which are designed to hold or be affixed to peripherals. These can be used to generate a form factor which is more similar to that of an object being used in-game, but do not vary the functionality of the peripheral itself. In other words, it is the user's interaction with the peripheral that is modified rather than the interaction with the content.

It is in the context of the above discussion that the present disclosure arises.

### SUMMARY OF THE INVENTION

This disclosure is defined by claim 1. Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates a view of a handheld controller;

FIGS. 3 and 4 schematically illustrate customised versions of the handheld controller;

FIG. 5 schematically illustrates a method by which a customised controller is able to be used with a processing device;

FIG. 6 schematically illustrates a system for enabling user interactions with interactive content executed by a processing device; and

FIG. 7 schematically illustrates a method for enabling user interactions with interactive content executed by a processing device.

### DESCRIPTION OF THE EMBODIMENTS

Referring now to the drawings, wherein like reference numerals designate identical or corresponding parts throughout the several views, embodiments of the present disclosure are described.

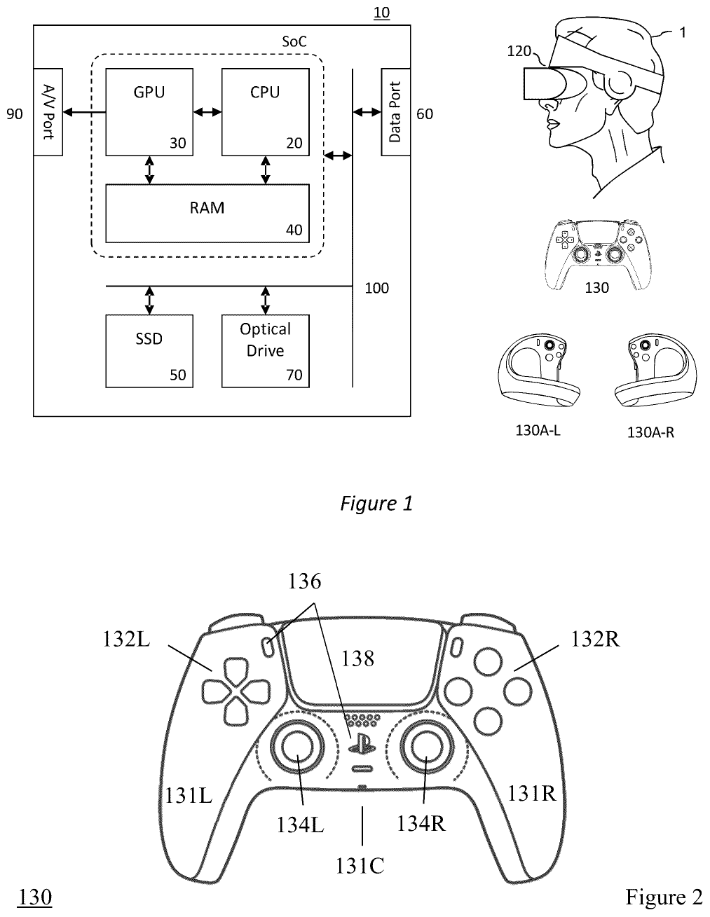

Referring to FIG. 1, an example of an entertainment system 10 is a computer or

console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

FIG. 2 schematically illustrates an enlarged view of the handheld controller 130. Such a controller typically has two handle sections 131L,R and a central body 131C. Various controls are distributed over the controller, typically in local groups. Examples include a left button group 132L, which may comprise directional controls and/or one or more shoulder buttons, and similarly right button group 132R, which comprise function controls and/or one or more shoulder buttons. The controller also includes left and/or right joysticks 134L,R, which may optionally also be operable as buttons by pressing down on them.

The controller (typically in the central portion of the device) may also comprise one or more system buttons 136, which typically cause interaction with an operating system of the entertainment device rather than with a game or other application currently running on it; such buttons may summon a system menu, or allow for recording or sharing of displayed content. Furthermore, the controller may comprise one or more other elements such as a touchpad 138, a light for optical tracking (not shown), a screen (not shown), haptic feedback elements (not shown), and the like.

Connectors may be provided on the controller, such as a USB port, to enable the communication with other devices (such as a games console with which the controller is to be used) and/or a battery charging functionality, for example.

Implementations of the present disclosure seek to provide additional functionality for such a controller so as to enable an improved interaction for a user with an associated processing device, such as a games console. This may be through the provision of additional sensors or input elements (such as buttons), for example.

While customisable controllers have been provided in the art, these are typically for accessibility purposes or to allow a user to personalise their interaction (such as the use of rear paddles to replace shoulder buttons). Such arrangements seek to modify the manner in which a controller is used to access the same features as a standard controller—and as such these arrangements represent a remapping of inputs rather than any additional functionality. This is because the same range of interactions are accessible by a user, albeit potentially in a different manner.

While discussions in this document are largely concerned with a controller with a form factor of that of the controller 130, this should not be regarded as limiting. While modifications may be required to implement the teachings herein with a controller of a differing form factor, these would be within the scope of routine modifications as the general principles would still apply and no significant technical problems would be expected to arise from an adaptation.

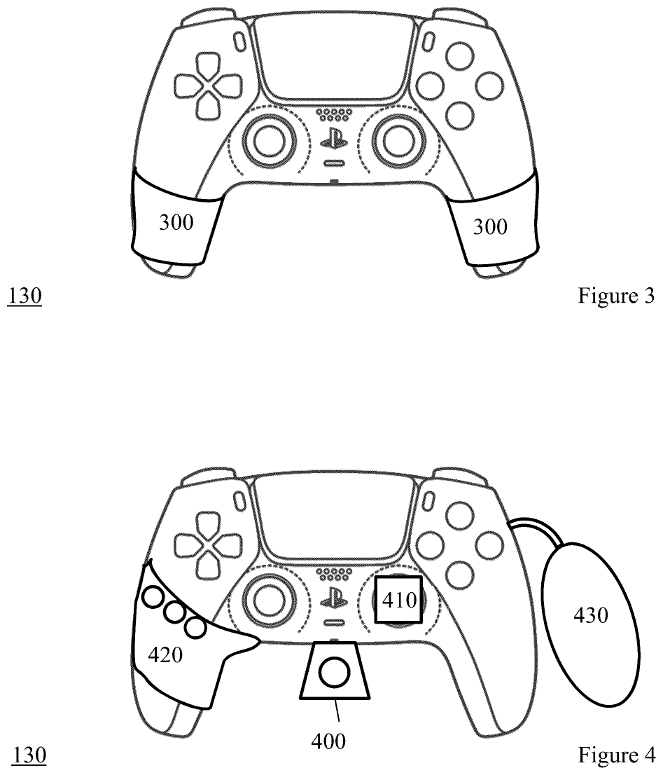

FIG. 3 schematically illustrates an example of a customisation applied to a controller. In particular, the controller 130 is enhanced with sleeves 300 which can offer any one or more additional functions. For instance, the sleeves 300 may include a heart rate monitor or pressure sensors which can be used as inputs to content being interacted with; the sleeves 300 may be particularly useful in such cases as they enable a user to interact with content in a more varied or nuanced manner without requiring additional button presses or the like. In some cases the sleeves 300 offer identical functionality, however this is not required as they may offer entirely different functions or one may offer a subset of the functionality of the other.

FIG. 4 also schematically illustrates an example of customisations applied to a controller. In particular, the controller 130 is enhanced with a plurality of different input elements 400, 410, 420, and 430. While shown here in combination, each of these input elements may be provided alone or in any other combination. In some cases, additional or duplicate elements may also be provided.

The input element 400 comprises an attachable button which offers new functionality. This input element 400 may be affixed to the controller in any suitable manner-in some cases, it may be inserted into a USB port or the like which is sufficient to hold the input element 400 in place, while in other cases it may be associated with a bracket or the like which allows for a temporary attachment to the controller 130. The attachable button may be functionally (that is, not visually) the same as the buttons 132R already on the controller 130, albeit with a different function, or may be different-for instance, offering a different degree of resistance, a different size, and/or a different operation (such as a button which travels along an axis different to the existing buttons, or which can be rotated as they are pressed).

The input element 410 comprises an attachable component which is affixed to the right joystick 134R of the controller 130. This input element 410 can be used to offer new functionality to the existing element, without impacting (or at least not significantly) the operation of that existing element. In some cases, the input element 410 may be provided as a sleeve or cap which is slipped or strapped over the top of the joystick 134R, although any method of affixing the input element 410 may be considered as appropriate. An example functionality of this element may be to provide a pressure sensor (or proximity sensor) which can generate inputs substantially independently of any push-button functionality of the joystick—for instance, by enabling the sensing of pressure lower than the threshold required to cause the push-button functionality to be triggered. Alternatively, or in addition, a sensor such as an accelerometer may be provided to enable the capture of more precise motion data (should such data not be captured by the joystick by default). A further example of a function that can be provided is that of a temperature or moisture sensor to monitor properties of the user's thumb when in contact with the input element 410.

The input element 420 is an example of a sleeve which may be similar in functionality to the sleeves 300 of FIG. 3; however, the input element 420 is provided with additional buttons or the like as shown in FIG. 4. These may be operated by the end of the user's thumb similarly to the buttons 132L, for example, or by the base of the user's thumb where appropriate. In some cases, the provision of the additional inputs may lead to a user interacting with the controller 130 in a different manner so as to enable easier use of these inputs—such as changing their grip. Buttons may also (or instead) be provided on the rear of the sleeve, for use by the user's fingers while gripping the controller 130.

The input element 430 is an example of an input element which is not affixed to the controller in a fixed manner. Instead, the input element 430 may be attached via a wire or tube that enables the input element 430 to be moved freely. In this case, the input element 430 may be a squeezable element which generates an input on a basis of the pressure applied. This pressure may be measured based upon a deformation of the input element 430, for instance, or based upon an air flow in and out of the input element 430. In some cases, due to the more flexible nature of the attachment, the input element 430 may be configured for use by a second person different to the holder of the controller. While in some cases the input element 430 may be used as a separate input, in other cases it may be used as a modifier for other inputs—such as pumping to ‘charge up’ a button press or the like.

The input elements discussed with reference to FIGS. 3 and 4 are considered to be purely exemplary, and are shown simply to illustrate possible implementations of the concept of controller customisation in accordance with implementations of the present disclosure. Additional or alternative input elements may offer any type of input functionality—sliders (that is, an element which is interacted with by sliding it along an axis substantially parallel to the surface of the controller at the point of attachment) are one example, with variation being offered by the fact that the slider can remain in place once moved (whereas a button/joystick would return to an initial position) as well as a good level of fine control. Similarly, rotating dials may be another example—these could be placed on top of the joystick elements to modify their inputs (such as a rotating dial being used to set a scaling factor for joystick motion), for example, or serve as standalone inputs located anywhere on the controller or its input elements.

One or more of the input elements may also provide outputs to the user (or specific output elements for these may be provided). For example, the sleeves shown in FIG. 3 may be configured to provide a heat sensation to a user which is indicative of an in-game parameter such as weapon use (simulating a weapon overheating through repeated use). Such a feature can offer additional functionality to a user in that a new mechanic within the game can be provided—in this case, managing weapon usage.

Each of the input elements which are associated with a controller may be communicably connected to the controller (or an external device, such as a breakout box or games console) via wireless or wired communication means, such as Bluetooth® or USB. Communications can include both input/sensor data and information identifying the input element as appropriate. Each of the input elements may include its own power supply or obtain power from the controller or an external device as desired.

In some implementations, it may be possible to identify the location of the input elements that are used to customise the controller. This may be achieved through the use of wireless communication signal strength, for example, or measurements by sensors on a controller (such as accelerometer measurements in response to haptic feedback or motion) which can be indicative of a weight distribution or the like associated with the controller. In some cases, the user may instead be able to define the location (or confirm a detected location). The location of the input elements may be used to vary the functionality of the elements as appropriate—for instance, the input element 430 of FIG. 4 may be used to modify the function of the buttons on the right, but if moved to the left then the functionality of those buttons on the left would be modified instead.

FIG. 5 schematically illustrates a method by which a customised controller is able to be used with a processing device (such as a games console or a computer).

A step 500 comprises identifying the controller and a corresponding base input mapping between inputs that are standard for that controller and functions corresponding to the processing device (such as an operating-system-level configuration) and/or content being executed upon that device (such as an in-game button mapping). In the case that the mapping is defined for the processing device (rather than the content), a second mapping may be identified which maps between the device functions to the content functions.

In other words, one or more input mappings are identified which correspond to the controller without any modifications or customisations applied, the input mapping or mappings being used to enable a user to interact with the processing system via operation of the controller.

A step 510 comprises identifying the customisations made to the controller arrangement. Customisations here refers to the provision of additional inputs and/or input modifiers, such as those discussed with reference to FIGS. 3 and 4, while reference to a ‘controller arrangement’ is indicative of the fact that the customisations need not modify the controller directly and instead may be simply associated with the controller (such as communicably connected, but otherwise not affixed, to the controller). For instance, a user may be provided with a ring or the like which can comprise biometric sensors and/or generate inputs when interacting with a controller or the like.

The customisations may be identified in any suitable manner—for instance, customisation elements (that is, the physical elements added to or otherwise associated with the controller) may be configured to output identification information by communicating with the controller or the processing device. Alternatively, or in addition, information about the customisations may be provided by a user (via a graphical user interface displayed by the processing device, for instance) or through an image recognition process performed upon an image captured of the controller. Such a process may be streamlined through the provision of a marker or the like which visually encodes the identity of the customisation element.

In addition to identifying the identity of the customisation elements that have been provided to the controller, the location of those elements with respect to the controller may also be identified. The location may be specified by a user, for example, and/or may be determined based upon communications between the customisation elements and the controller or processing device which enable a location to be determined (such as based upon signal strength of a signal emitted by an element). Alternatively, or in addition, images may be captured of the controller arrangement which can be used to automatically determine the location of elements (or can be displayed to a user to allow them to label elements within a captured image).

A step 520 comprises generating an updated input mapping for the customised controller. This updated input mapping includes one or more additional functions which are not defined in the base mapping identified in step 500, or at least are not assignable as a part of that mapping. For instance, in the case of the mapping being defined for a particular controller arrangement and game pairing the updated input mapping the additional functions may be one or more actions that were not previously accessible to the user's character.

For example, when providing an input element such as the element 430 of FIG. 4 (which comprises a squeezable element) a user's character may gain access to wind spells (reflective of the ability to pump air as an input for those spells) which were not previously usable by the character. Alternatively, the user may gain access to a variable grip function when handling items in which the strength of the grip corresponds to the force applied to the squeezable element. In some cases, a user's character may be provided with a new item while the customisation element is attached, with the item being operated using that corresponding element. Such an input element may be operated on the basis of measured air flow due to a user's squeeze, or any other squeeze sensor such as a piezoelectric or pressure sensor.

The updated input mapping is defined based upon the identity of the customisation elements associated with the controller arrangement. Optionally, the input mapping for a given customisation element may be dependent upon the location of that element with respect to the controller arrangement. Alternatively, or in addition, the input mapping for a given customisation element may be dependent upon the identity (and optionally location) of one or more other customisation elements. This can be to account for synergies between inputs or input types, for example, or the ability to operate two elements simultaneously (for instance, two inputs on the same side may be harder to operate simultaneously than two inputs on opposite sides due to physical constraints).

The updated input mapping may be generated by a processing device or particular software using predefined information about a particular customisation element or function. For instance, a game developer may define a number of functions which are not accessible by a basic controller (that is, one which has not been customised) along with an indication of which customisation element each function should correspond to. Rather than indicating a specific customisation element, in some cases it may be preferable to indicate a type of element (such as an input type, for instance ‘button’ or ‘squeezable element’) which should correspond to that function.

In some cases, a user may be able to select one or more functions from a list of non-assigned functions so as to generate the mapping manually. Alternatively, in some cases a model may be provided which obtains information about the customisation elements associated with a controller and functions which are able to be assigned to these elements, and generates a suitable input mapping based upon those inputs. Such a model may be defined or trained based upon historical usage data for the elements and/or functions, such as usage in other content (for instance, earlier games in a series or the same genre) and/or beta testing or early release statistics indicating user preferences. In some cases, the model may be trained based upon historical usage data which includes information about effectiveness or levels of use to determine a suitable mapping—this can enable a mapping to be selected which is associated with higher levels of success (encouraging more effective use) and/or use (encouraging more frequent use) as preferred.

A step 530 comprises receiving an input from the customised controller and performing a function at the processing device in dependence upon the received input. As noted above, in the case that the input is provided via a customisation element the performed function is one which would be inaccessible to a user of a non-customised controller.

Implementations of methods according to that exemplified by FIG. 5 therefore provide a user with the ability to customise a controller with additional input elements, and to access previously-inaccessible (even by remapping keys) functionality as a result.

In some cases, control signals may be sent to the controller and/or customisation elements as appropriate to cause an interaction with the customisation elements. For instance, based upon a detected game state or the like control may be performed to cause a customisation element to light up or emit a sound indicating that a corresponding function can be used (such as a game context indicating an appropriate use time for an ability, or a spell cool-down expiring). Customisation elements may also be configured to provide haptic feedback or the like to a user, or to vary one or more operational parameters (such as a resistance to operation) to modify the user's interaction with the customisation element.

It may be considered advantageous in some implementations to display one or more aspects of a controller to enable the user to identify the customisations which have been made. This may be particularly beneficial in the case that a user is wearing a head-mountable display which obscures the user's view of the customised controller during operation (such as a virtual reality or full-immersion display). In some cases, at least a portion of the controller and the associated customisation elements are displayed to the user. Alternatively, one or more parts of a displayed image may be modified to reflect the customisation elements present. For instance, a user's avatar or an item associated with the avatar may be reskinned or have its appearance modified to reflect new functionality or the use of a particular customisation element.

While described above in the context of a user generating an arrangement of customisation elements to be associated with the controller, in some cases the processing device may be configured to advise or instruct in this respect. This may include suggesting rearrangement of one or more customisation elements to improve comfort or effectiveness (such as putting more frequently used elements within easier reach), for example. In some cases, a user profile or other database may indicate the customisation elements available to the user and suggestions may be provided indicating a particularly effective or otherwise appropriate (such as comfortable) selection/arrangement of such elements. These may be based upon statistical analysis of other players and their customisations, for instance, content developer input, and/or pre-generated configurations obtained from a repository (such as user-submitted configurations for particular content).

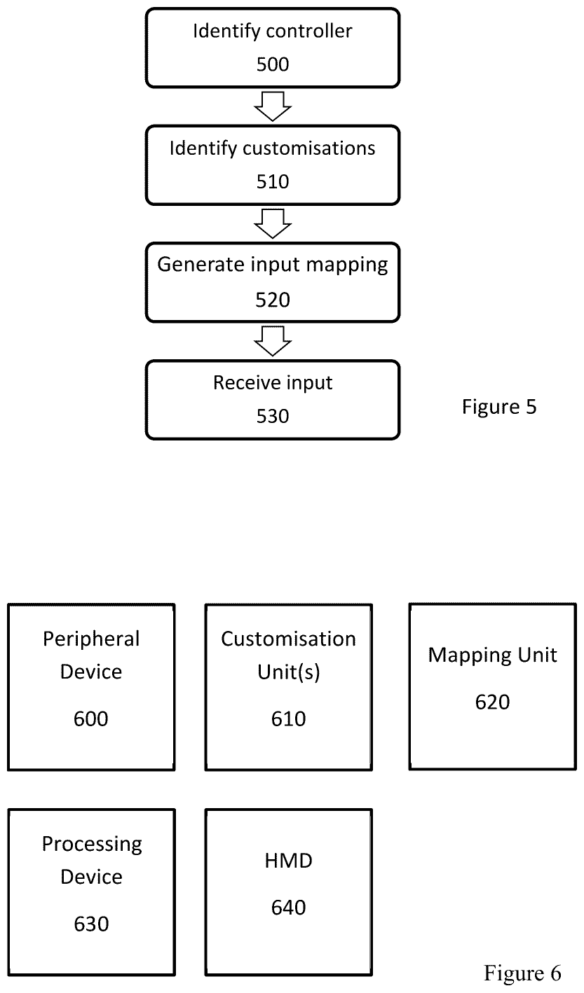

FIG. 6 schematically illustrates a system for enabling user interactions with interactive content executed by a processing device. The system comprises a peripheral device 600, one or more customisation units 610, a mapping unit 620, and optionally one or both of the processing device 630 itself and a display unit such as an HMD 640. The processing device 630 may be implemented as a local games console or computer, for example, or may be implemented as a cloud processing arrangement. In some implementations, the functionality of the mapping unit 620 may be provided by the processing device 630.

The peripheral device 600 comprises one or more first input elements; this may be exemplified by the controller 130 of FIG. 2 with input elements such as the buttons 132L and 132R. However, any form factor of peripheral may be considered suitable, and any combination of input elements, rather than being limited to those of the example of FIG. 2. The peripheral device 600 is communicatively connected to the processing device 630, so as to enable a user to provide inputs to control processing of interactive content being executed by the processing device 630.

The one or more customisation units 610 comprise one or more second input elements, wherein the customisation units are modular units associated with the peripheral device by a user. Customisation units 610 may be considered to be equivalent to the customisation elements discussed above with reference to FIG. 5, in that they are units which provide additional functionality to the peripheral through the provision of additional input elements. Each of the customisation units 610 may include one or more input elements, and these may include one or more of buttons, joysticks, triggers, touchpads, proximity sensors, squeeze sensors, and/or accelerometers for example.

The term ‘modular units’ used above refers to the fact that the customisation units 610 can be provided as separate elements which can be associated with the peripheral device 600 so as to add additional functionality to that device. In some cases, at least one of the one or more customisation units 610 is affixed to the peripheral device; however, it is also considered that the customisation units 610 may be connected only by a cable or the like (such as the element 430 of FIG. 4), or may be a standalone element which communicates wirelessly with the controller (or is simply used in combination, and instead communicates directly with the processing device 630). As exemplified by the element 410 of FIG. 4, in some cases one or more customisation units 610 may be affixed to one or more of the first input elements of the peripheral device 600.

In some implementations, one or more of the customisation units 610 are configured to communicate operation information to the peripheral device 600, in response to which the operation input is communicated to the processing device 630 so as to cause an interaction with the interactive content. However, in some cases it may be considered advantageous that one or more of the customisation units 610 are configured to communicate operation information to the processing device 630 directly. Such communications may be performed via any wired or wireless means as appropriate.

The mapping unit 620 is configured to generate an input mapping, wherein the input mapping comprises one or more functions assigned to the one or second input elements which are not able to be assigned to the first input elements. In other words, the use of the customisation units 610 enables a user to access new functionality associated with the processing device 630 or a particular interactive content. This therefore extends beyond a simple remapping of functions or the like, as it is considered that a mapping of the functionality is only enabled by the use of customisation units 610.

The generated mapping may be stored locally or remotely, in some cases in association with a user profile to enable easy retrieval at a later time. The mapping may be generated for immediate use, for instance during execution of a game, or it may be generated for future use such as during a start-up process of a games console or part of a calibration/set-up process for the peripheral 600 or processing device 630. Such a calibration/set-up process may be initiated in response to the detection of a new customisation unit 610 being associated with the peripheral 600, for example, or a new arrangement of customisation units 610.

While in some cases the functionality may be provided as a premium feature (or the like) associated with a given customisation unit 610, the intended use case is to address functional limitations of the peripheral 600. The technical issue of an insufficient number of input elements being provided, or an insufficient range of input element types, can therefore be addressed in an efficient and effective manner by the use of customisation units 610. This can preclude the need to provide multiple peripherals with increasingly complex and/or varied inputs, as a user can instead simply configure their own peripheral so as to enable compatibility.

In the case that a user is not using an appropriate customisation unit 610 so as to enable access to a given function in interactive content, such a function may be simplified or otherwise modified so as to omit certain aspects of the interaction which would depend upon an input from that customisation unit. Alternatively, the function may be automated to remove the need for that customisation unit 610 to achieve a particular interaction.

For instance, in the case that the function in question is the use of variable grip strength when picking up an object (which may be implemented using a squeeze sensor or similar input, such as 430 of FIG. 4) if an appropriate customisation unit is not in use then the optimal grip strength or a default value may be selected so as to avoid such functionality entirely. Of course, the inverse approach may be adopted in which existing content is able to be enriched with new interactions or functionality in response to new customisation units being identified—such as replacing a simple or automated function with a full interaction which utilises the new input.

In some cases, the mapping utilises a possible function list provided by interactive content to indicate the range of possible functions that can be assigned to a given input. Such a list may further comprise information which is used to inform the mapping process, such as indicating a preferred input type for a function and/or a particular customisation unit 610 which is intended to correspond to that function. Alternatively, or in addition, a model (such as a trained machine learning model) may be provided which is configured to generate the mapping in an automated fashion. In some implementations, user inputs may also (or instead) be used to generate the mapping, such as a user selecting a particular function to be assigned to the customisation units.

The processing device 630 is configured to execute interactive content, such as a video game or another application, in dependence upon inputs received from a user via the peripheral 600 and customisation units 610. The inputs are interpreted in accordance with the generated mapping as described above.

The processing device 630 may be a games console, for example, mobile device, or a personal computer or the like. Any suitable accessories (or integrated functionality) may be provided to assist with implementing features of the present disclosure—for instance, a camera may be provided which is operable to capture images of the peripheral device 600 and the customisation units 610.

The processing device 630 may be optionally configured to determine an identity and/or arrangement relative to the peripheral device 600 of the one or more customisation units 610 in dependence upon a captured image comprising the peripheral device 600. The image may be captured by a camera associated with the processing device 630, or it may be provided to the processing device 630 by an external device, such as the user's mobile phone.

In some implementations, the processing device 630 is configured to modify the appearance of an aspect of the interactive content in dependence upon the customisation units communicably connected to the peripheral device. For example, one or more of the customisation units 610 may be shown (in some cases, with an indication of the corresponding function and/or availability for use), or an aspect of the user's avatar or items may be modified to reflect the use of particular customisation units. In some cases, the modifications may be based upon the new functionality rather than a specific customisation unit—in the example described above of a variable grip strength, the avatar may be provided with a new pair of gloves or the like to reflect a deviation from typical functionality.

The processing device 630 may be configured to generate an output to a user indicating an updated selection of customisation units 610 in dependence upon a user profile indicating customisation units 610 available to the user. In other words, based upon information about which customisation units 610 a user owns (such as information obtained from a user's profile, usage history, and/or purchase history) the processing device 630 may be able to generate an optimal configuration for the user and/or interactive content. This may be a configuration which offers an advantageous combination of functions, for instance, or an improved ease of interaction. This may be based upon data obtained from other players' play statistics, for example, or information from a developer indicating preferred configurations.

In some implementations, the processing device 630 may be configured to generate

an output which causes one or more customisation units 610 to emit light, sound, and/or haptic feedback in dependence upon a state of the interactive content. Such an output may be generated in response to a function becoming available (such as a game state allowing its use, or a cool down period expiring), in which case the output is generated to control the customisation unit (or units) 610 which corresponds to the function.

The head-mountable display device (HMD) 640 is an example of a display device which is configured to output images of the interactive content generated by the processing device 630, such as rendered images generated by executing a game. While an HMD 640 may be preferred for providing an immersive user experience, it is considered that any type of display may be used to display the images output by the processing device 630.

The arrangement of FIG. 6 is an example of hardware that is operable to enable user interactions with interactive content executed by a processing device, and in particular is operable to generate an input mapping, wherein the input mapping comprises one or more functions assigned to the one or second input elements which are not able to be assigned to the first input elements. The hardware comprises a peripheral device comprising one or more first input elements, one or more customisation units comprising one or more second input elements, wherein the customisation units are modular units associated with the peripheral device by a user, and both a processing device 630 and HMD 640. The functionality of the mapping unit 620 and the processing device 630 may be implemented by any suitable processing units (for example, CPUs and/or GPUs such as those indicated by the references 20 and 30 in FIG. 1).

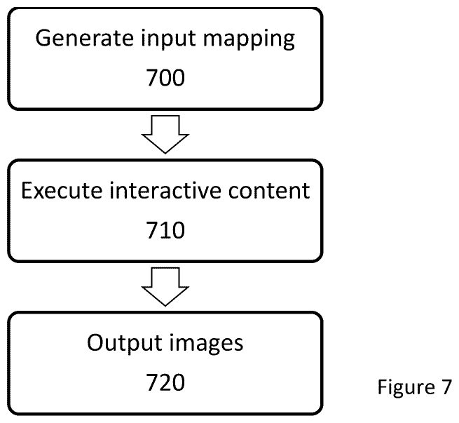

FIG. 7 schematically illustrates a method for enabling user interactions with interactive content executed by a processing device, the interactions being performed using a peripheral device comprising one or more first input elements and one or more customisation units comprising one or more second input elements, wherein the customisation units are modular units associated with the peripheral device by a user. Such an arrangement is discussed above with reference to FIG. 6.

A step 700 comprises generating an input mapping, wherein the input mapping comprises one or more functions assigned to the one or second input elements which are not able to be assigned to the first input elements.

A step 710 comprises executing interactive content, such as a video game or another application, in dependence upon inputs received from a user via the peripheral 600 and customisation units 610. The inputs are interpreted in accordance with the generated mapping as described above.

A step 720 comprises outputting images of the interactive content generated by the processing device.

While shown as a process comprising three steps in FIG. 7, it is considered that the mapping may be generated independently of an interaction with the interactive content-for instance, in a pre-game calibration/set-up process. It is therefore considered that steps 710 and 720 are optional in some implementations of the present disclosure.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the present disclosure may be implemented in accordance with any one or more of the following numbered clauses:

1. A system for enabling user interactions with interactive content executed by a processing device, the system comprising:
a peripheral device comprising one or more first input elements;
one or more customisation units comprising one or more second input elements, wherein the customisation units are modular units associated with the peripheral device by a user;
a mapping unit configured to generate an input mapping, wherein the input mapping comprises one or more functions assigned to the one or second input elements which are not able to be assigned to the first input elements.

2. A system according to clause 1, wherein at least one of the one or more customisation units is affixed to the peripheral device.

3. A system according to any preceding clause, wherein at least one of the one or more customisation units is affixed to one or more of the first input elements of the peripheral device.

4. A system according to any preceding clause, wherein the one or more second input elements include one or more of buttons, joysticks, triggers, touchpads, proximity sensors, squeeze sensors, and/or accelerometers.

5. A system according to any preceding clause, wherein one or more of the customisation units are configured to communicate operation information to the peripheral device.

6. A system according to any preceding clause, wherein one or more of the customisation units are configured to communicate operation information to the processing device.

7. A system according to any preceding clause, comprising the processing device configured to execute interactive content.

8. A system according to clause 7, wherein the processing device is configured to determine an identity and/or arrangement relative to the peripheral device of the one or more customisation units in dependence upon a captured image comprising the peripheral device.

9. A system according to clause 7 or clause 8, wherein the processing device is configured to modify the appearance of an aspect of the interactive content in dependence upon the customisation units communicably connected to the peripheral device.

10. A system according to any of clauses 7-9, wherein the processing device is configured to generate an output to a user indicating an updated selection of customisation units to be associated with the peripheral device by the user, the output being generated in dependence upon a user profile indicating which customisation units are available to the user.

11. A system according to any of clauses 7-10, wherein the processing device is configured to generate an output which causes a customisation unit to emit light, sound, and/or haptic feedback in dependence upon a state of the interactive content.

12. A system according to any preceding clause, comprising a head-mountable display device configured to output images of the interactive content generated by the processing device.

13. A method for enabling user interactions with interactive content executed by a processing device, the interactions being performed using a peripheral device comprising one or more first input elements and one or more customisation units comprising one or more second input elements, wherein the customisation units are modular units associated with the peripheral device by a user, the method comprising:
generating an input mapping, wherein the input mapping comprises one or more functions assigned to the one or second input elements which are not able to be assigned to the first input elements.

14. Computer software comprising instructions which, when the software is executed by a computer, causes the computer to carry out the method of clause 13.

15. A non-transitory machine-readable storage medium which stores computer software according to clause 14.

1. A system for enabling user interactions with interactive content executed by a processing device, the system comprising:
a peripheral device comprising one or more first input elements;
one or more customisation units comprising one or more second input elements, wherein the customisation units are modular units associated with the peripheral device by a user;
a mapping unit configured to generate an input mapping, wherein the input mapping comprises one or more functions assigned to the one or second input elements which are not able to be assigned to the first input elements.

2. The system of claim 1, wherein at least one of the one or more customisation units is affixed to the peripheral device.

3. The system of claim 1, wherein at least one of the one or more customisation units is affixed to one or more of the first input elements of the peripheral device.

4. The system of claim 1, wherein the one or more second input elements include one or more of buttons, joysticks, triggers, touchpads, proximity sensors, squeeze sensors, and/or accelerometers.

5. The system of claim 1, wherein one or more of the customisation units are configured to communicate operation information to the peripheral device.

6. The system of claim 1, wherein one or more of the customisation units are configured to communicate operation information to the processing device.

7. The system of claim 1, comprising the processing device configured to execute interactive content.

8. The system of claim 7, wherein the processing device is configured to determine an identity and/or arrangement relative to the peripheral device of the one or more customisation units in dependence upon a captured image comprising the peripheral device.

9. The system of claim 7, wherein the processing device is configured to modify the appearance of an aspect of the interactive content in dependence upon the customisation units communicably connected to the peripheral device.

10. A system according to claim 7, wherein the processing device is configured to generate an output to a user indicating an updated selection of customisation units to be associated with the peripheral device by the user, the output being generated in dependence upon a user profile indicating which customisation units are available to the user.

11. A system according to claim 7, wherein the processing device is configured to generate an output which causes a customisation unit to emit light, sound, and/or haptic feedback in dependence upon a state of the interactive content.

12. The system of claim 1, comprising a head-mountable display device configured to output images of the interactive content generated by the processing device.

13. A method for enabling user interactions with interactive content executed by a processing device, the interactions being performed using a peripheral device comprising one or more first input elements and one or more customisation units comprising one or more second input elements, wherein the customisation units are modular units associated with the peripheral device by a user, the method comprising:
generating an input mapping, wherein the input mapping comprises one or more functions assigned to the one or second input elements which are not able to be assigned to the first input elements.

14. A non-transitory machine-readable storage medium which stores computer software which, when executed by a computer, causes the computer to perform a method for enabling user interactions with interactive content executed by a processing device, the interactions being performed using a peripheral device comprising one or more first input elements and one or more customisation units comprising one or more second input elements, wherein the customisation units are modular units associated with the peripheral device by a user, the method comprising:
generating an input mapping, wherein the input mapping comprises one or more functions assigned to the one or second input elements which are not able to be assigned to the first input elements.
